(19) United States
(12) Patent Application Publication
(10) Pub. No.: US 2019/0120301 A1
(43) Pub. Date: Apr. 25, 2019

(54) Positioning structure for clutch of engine of remote control model

(71) Applicant: Nai Wen LIU, Taichung City (TW)

(72) Inventor: Nai Wen LIU, Taichung City (TW)

(21) Appl. No.: 15/968,732

(22) Filed: May 1, 2018

(30) Foreign Application Priority Data
Oct. 23, 2017 (TW) 106215583

(51) Int. Cl. F16D 43/18

(52) U.S. Cl. CPC F16D 43/18; F16D 2043/145

(57) ABSTRACT

A positioning structure for a clutch of an engine of a remote control model contains: a flywheel, multiple connection parts, multiple torsion springs, and multiple limitation elements. The flywheel includes a fitting element, a nut, and multiple fixing posts. Each of the multiple connection parts includes two opposites through orifices, an accommodation chamber, an abutting portion, and a recess. Each of the multiple torsion springs has a first central hole, a first contact segment, and a second contact segment. Each of the multiple limitation elements is rotatably fixed between each fixing post of the flywheel and the first central hole of each torsion spring, wherein each limitation element includes a support portion concentric with each fixing post, and the support portion has a second central hole rotatably fitted with each fixing post and has an external fence contacting with the first central hole.

### FIELD OF THE INVENTION

The present invention relates to a positioning structure for a clutch of an engine of a remote control model which avoids failure of multiple connection parts as shaking the multiple connection parts and improves performance of the engine.

### BACKGROUND OF THE INVENTION

Referring to FIGS. 4 and 5, a conventional clutch of an engine of a remote control model is connected on an output shaft 1a of the engine 1 of the remote control model, and the clutch contains a fitting element 2, three connection parts 3, three torsion springs 4, and a casing 5.

The fitting element 2 includes a fitting element 2a locked on the output shaft 1a by a nut 2b, and the fitting element 2 includes three fixing posts 2c separately arranged around the fitting element 2a.

Each of the three connection parts 3 includes two opposites through orifices 3a formed on a first end thereof, an accommodation chamber 3b defined between the two opposite through orifices 3a so as to accommodate the three fixing posts 2c, an abutting portion 3c formed on a second end of each connection part 3 opposite to the first end of each connection part 3.

The three torsion springs 4 are accommodated in the accommodation chamber 3b, and each of the three torsion springs 4 includes a central hole 4a, a first contact segment 4b and a second contact segment 4c which are arranged on two sides of each torsion spring 4 individually, wherein the first contact segment 4b abuts against a recess 3d of each connection part 3, and the second contact segment 4c is biased against the fitting element 2a of the flywheel 1.

The casing 5 accommodates the three connection parts 3.

The output shaft 1a rotate after starting the engine, wherein when the output shaft 1a rotates in a low speed, the three connection parts 3 are limited by the three torsion springs 4 respectively so as not to actuate the casing 5. When the output shaft 1a rotates in a high speed, the three connection parts 3 resist against centrifugal force of the three torsion springs 3 so that three abutting portion 3c of the three connection parts 3 move outward to engage with an inner wall of the casing 5 and to drive the casing 5 and a transmission gear 5a to rotate, thus actuating the remote control model to move forward and backward.

As illustrated in FIG. 5, an inner diameter of the central hole 4a is more than an diameter of each fixing post 2c, so the central hole 4a cannot be always concentric with each fixing post 2c, hence each torsion spring 4 cannot push each connection part 3 efficiently.

The present invention has arisen to mitigate and/or obviate the afore-described disadvantages.

### SUMMARY OF THE INVENTION

The primary aspect of the present invention is to provide a positioning structure for a clutch of an engine of a remote control model which avoids failure of multiple connection parts as shaking the multiple connection parts and improves performance of the engine.

To obtain above-mentioned aspect, a positioning structure for a clutch of an engine of a remote control model provided by the present invention contains: a flywheel, multiple connection parts, multiple torsion springs, and multiple limitation elements.

The flywheel is connected on an output shaft of the engine of the remote control model, and the flywheel includes a fitting element, a nut for locking the fitting element, and multiple fixing posts separately arranged around the fitting element.

The multiple connection parts are rotatably connected with the multiple fixing posts respectively, each of the multiple connection parts includes two opposites through orifices defined on a first end of each connection part, an accommodation chamber defined between the two opposite through orifices so as to accommodate each of the multiple fixing posts, an abutting portion formed on a second end of each connection part opposite to the first end of each connection part, and a recess formed in the accommodation chamber adjacent to the abutting portions.

The multiple torsion springs are rotatably housed in the multiple accommodation chambers of the multiple connection parts respectively, each of the multiple torsion springs has a first central hole, a first contact segment and a second contact segment which are arranged on two sides of each torsion spring individually, wherein the first contact segment abuts against the recess of each connection part, and the second contact segment is biased against the fitting element of the flywheel.

Each of the multiple limitation elements is rotatably fixed between each fixing post of the flywheel and the first central hole of each torsion spring, each limitation element includes a support portion concentric with each fixing post, and the support portion of each limitation element is rotatably fitted with the first central hole of each torsion spring.

### BRIEF DESCRIPTION OF THE DRAWINGS

FIG. 1 is a perspective view showing the exploded components of a positioning structure for a clutch of an engine of a remote control model according to a preferred embodiment of the present invention.

FIG. 2 is a perspective view showing the assembly of the positioning structure for the clutch of the engine of the remote control model according to the preferred embodiment of the present invention.

FIG. 3 is a cross sectional view showing the assembly of the positioning structure for the clutch of the engine of the remote control model according to the preferred embodiment of the present invention.

FIG. 4 is a perspective view showing the exploded components of a conventional clutch of an engine of a remote control model.

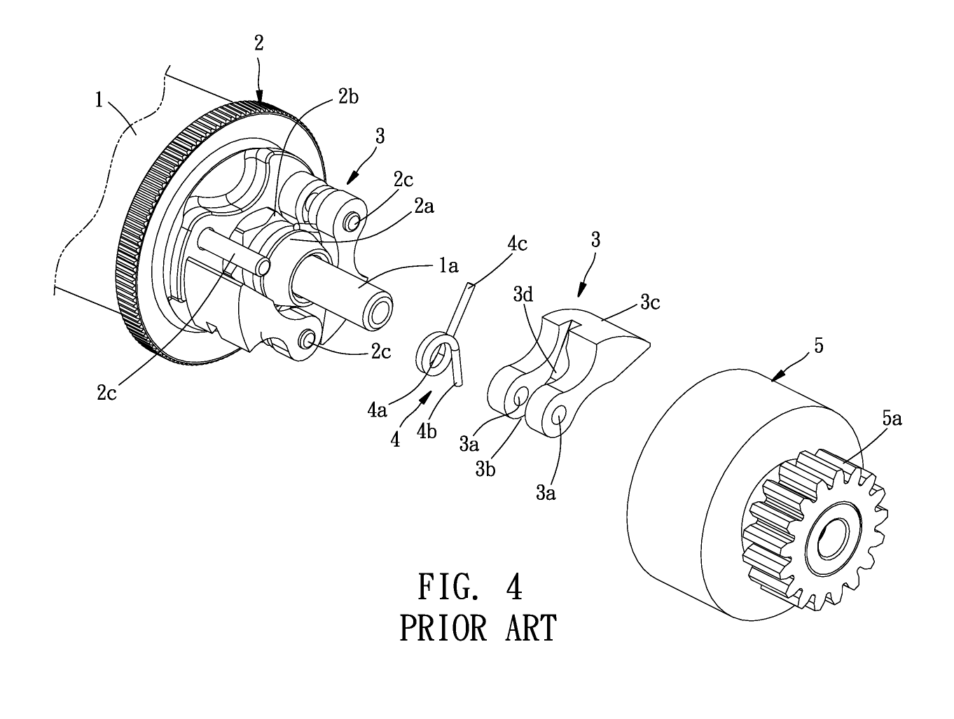

FIG. 5 is a cross sectional view showing the assembly of the conventional clutch of the engine of the remote control model.

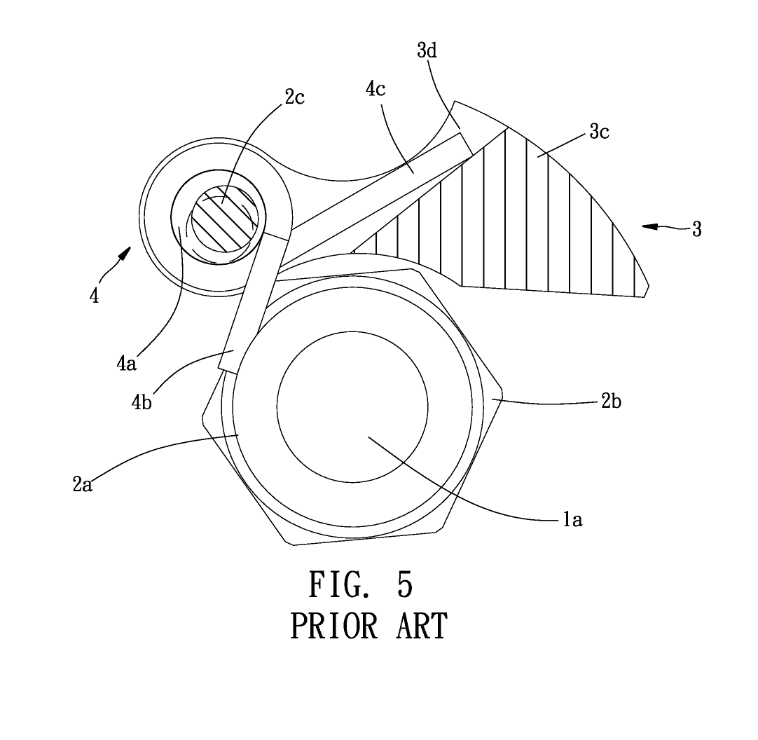

### DETAILED DESCRIPTION OF THE PREFERRED EMBODIMENTS

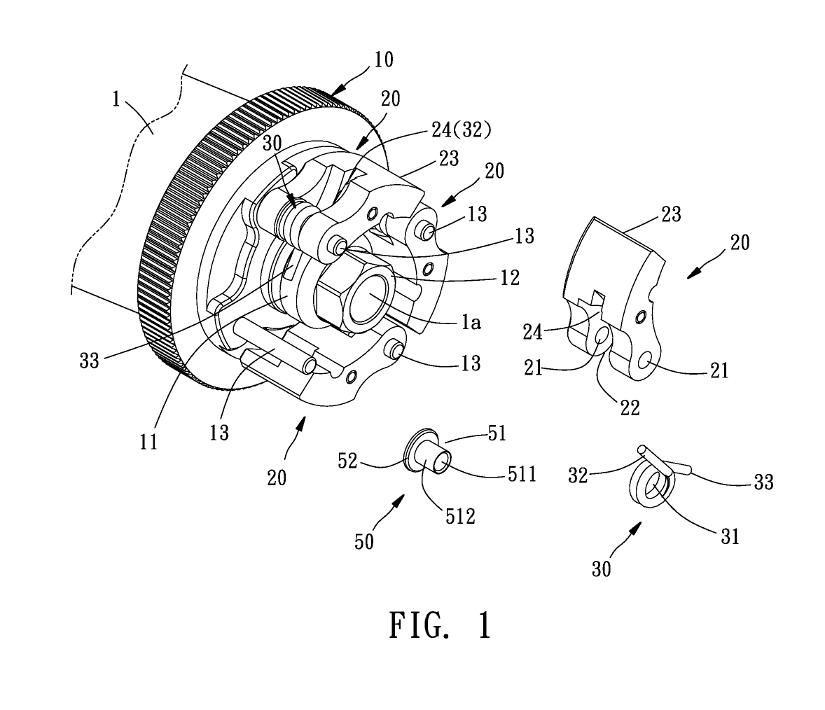

With reference to FIGS. 1-3, a positioning structure for a clutch of an engine of a remote control model according to a preferred embodiment of the present invention comprises: a flywheel 10, four connection parts 20, four torsion springs 30, a casing 40, and four limitation elements 50.

The flywheel 10 is connected on an output shaft 1a of the engine 1 of the remote control model, and the flywheel 10 includes a fitting element 11, a nut 12 for locking the fitting element 11, four fixing posts 13 separately arranged around the fitting element 11.

The four connection parts 20 are rotatably connected with the four fixing posts 13 respectively, each of the four connection parts 20 includes two opposites through orifices 21 defined on a first end of each connection part 20, an accommodation chamber 22 defined between the two opposite through orifices 21 so as to accommodate each of the four fixing posts 13, an abutting portion 23 formed on a second end of each connection part 20 opposite to the first end of each connection part 20, and a recess 24 formed in the accommodation chamber 22 adjacent to the abutting portions 23.

The four torsion springs 30 are rotatably housed in four accommodation chambers 22 of the four connection parts 20 respectively, each of the four torsion springs 31 has a first central hole 31, a first contact segment 32 and a second contact segment 33 which are arranged on two sides of each torsion spring 30 individually, wherein the first contact segment 32 abuts against the recess 24 of each connection part 20, and the second contact segment 33 is biased against the fitting element 11 of the flywheel 10.

The casing 40 is rotatably fitted with the flywheel 10 and accommodates the four connection parts 20, the casing 40 includes a transmission gear 41 mounted on an outer end surface thereof.

Each of the four limitation elements 50 is rotatably fixed between each fixing post 13 of the flywheel 10 and the first central hole 31 of each torsion spring 30, and each limitation element 50 includes a support portion 51 concentric with each fixing post 13, wherein the support portion 51 has a second central hole 511 and an external fence 512, the second central hole 511 is rotatably fitted with each fixing post 13, and the external fence 512 of each limitation element 50 contacts with the first central hole 31 of each torsion spring 30, wherein each limitation element 50 further includes a shoulder 52 extending around a bottom of the external fence 512 so as to fix the first central hole 31 of each torsion spring 30.

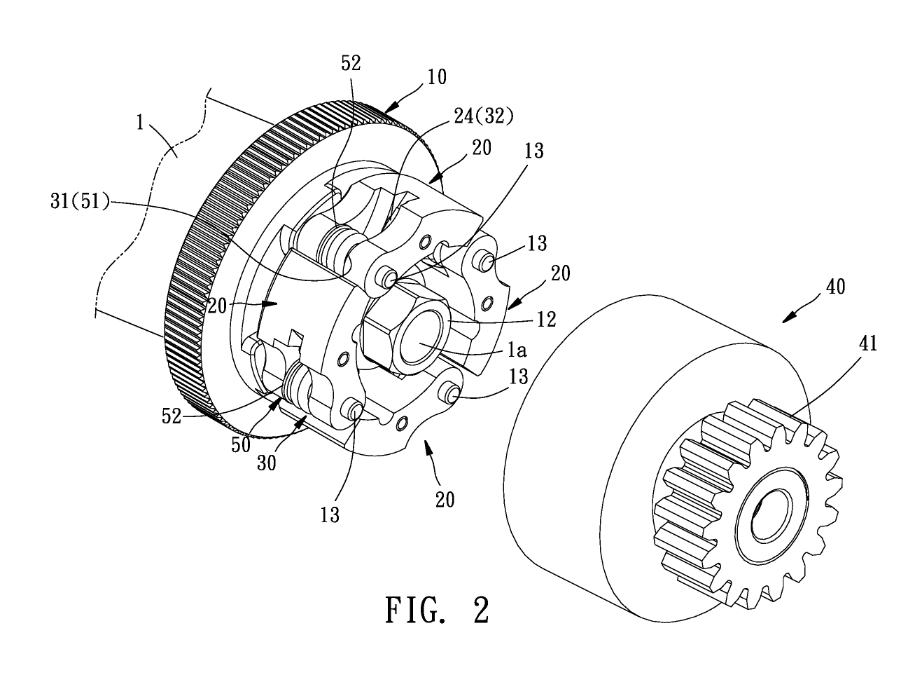

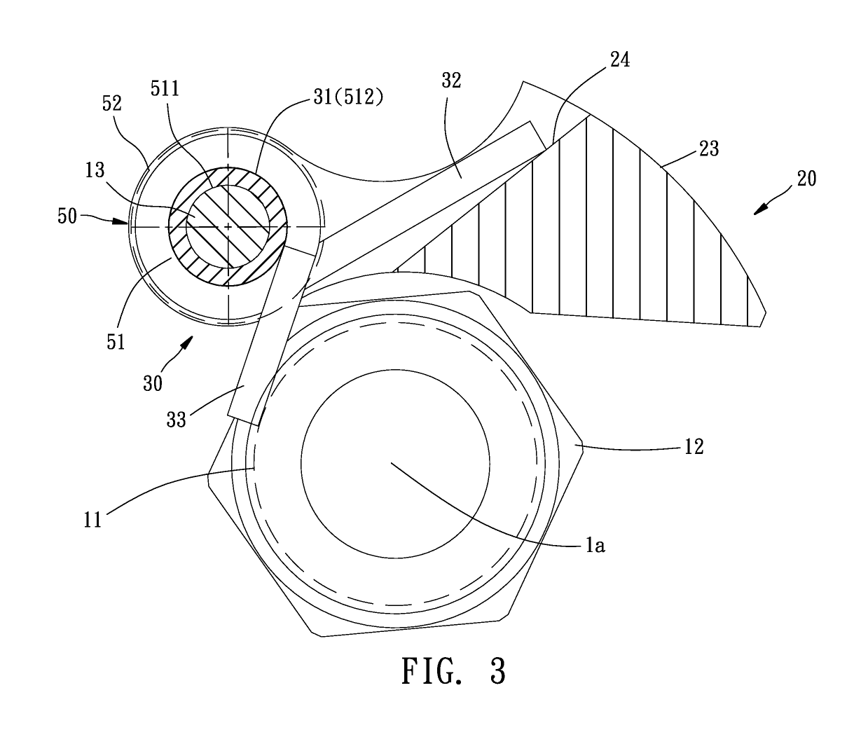

In assembly, the first central hole 31 of each torsion spring 30 is rotatably fitted with the support portion 51 of each limitation element 50, the shoulder 52 limits the first central hole 31 of each torsion spring 30, and each limitation element 50 and each torsion spring 30 are housed in the accommodation chamber 22 of each connection part 20, then the two opposites through orifices 21 of each connection part 20 are fitted with each fixing post 13 of the flywheel 10. As shown in FIGS. 2 and 3, the each fixing post 13 of the flywheel 10 inserts through the second central hole 511 of each limitation element 50 and the first central hole 31 of each torsion spring 30 so as to rotatably connect with the opposites through orifices 21 of each connection part 20, wherein the first contact segment 32 of each torsion spring 30 contacts with the recess 24 of each connection part 20, and the second contact segment 33 of each torsion spring 30 is biased against the fitting element 11 of the flywheel 10 so that each connection part 20 is connected with the flywheel 10, and the casing 40 is fitted on the flywheel 10, thus connecting the clutch of the remote control model.

Referring to FIG. 3, the each fixing post 13 of the flywheel 10 inserts through the second central hole 511 of each limitation element 50 and the first central hole 31 of each torsion spring 30 so as to rotatably connect with the opposites through orifices 21 of each connection part 20, wherein the external fence 512 of each limitation element 50 contacts with the first central hole 31 of each torsion spring 30 so that each torsion spring 30 rotates along each limitation element 50 and each connection part 20 swings securely, thus controlling the engine of the remote control model stably.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A positioning structure for a clutch of an engine of a remote control model comprising:
a flywheel connected on an output shaft of the engine of the remote control model, and the flywheel including a fitting element, a nut for locking the fitting element, and multiple fixing posts separately arranged around the fitting element;
multiple connection parts rotatably connected with the multiple fixing posts respectively, each of the multiple connection parts including two opposites through orifices defined on a first end of each connection part, an accommodation chamber defined between the two opposite through orifices so as to accommodate each of the multiple fixing posts, an abutting portion formed on a second end of each connection part opposite to the first end of each connection part, and a recess formed in the accommodation chamber adjacent to the abutting portions;
multiple torsion springs rotatably housed in the multiple accommodation chambers of the multiple connection parts respectively, each of the multiple torsion springs having a first central hole, a first contact segment and a second contact segment which are arranged on two sides of each torsion spring individually, wherein the first contact segment abuts against the recess of each connection part, and the second contact segment is biased against the fitting element of the flywheel; and
multiple limitation elements, wherein each of the multiple limitation elements is rotatably fixed between each fixing post of the flywheel and the first central hole of each torsion spring, each limitation element includes a support portion concentric with each fixing post, and the support portion of each limitation element is rotatably fitted with the first central hole of each torsion spring.

2. The positioning structure as claimed in claim 1, wherein the support portion of each limitation element has a second central hole and an external fence, the second central hole is rotatably fitted with each fixing post of the flywheel, and the external fence of each limitation element contacts with the first central hole of each torsion spring.

3. The positioning structure as claimed in claim 1, wherein each limitation element further includes a shoulder extending around a bottom of the external fence so as to fix the first central hole of each torsion spring.
